(19) United States
(12) Patent Application Publication
(10) Pub. No.: US 2009/0106253 A1
(43) Pub. Date: Apr. 23, 2009

(54) PORTAL EVENT VERIFICATION

(76) Inventor: ILJA FISCHER, Bad Schoenborn (DE)

Correspondence Address: SAP AG, 3410 HILLVIEW AVENUE, PALO ALTO, CA, 94304, US

(21) Appl. No.: 11/875,966

(22) Filed: Oct. 22, 2007

(51) Int. Cl. G06F 17/30

(52) U.S. Cl. 707/10; 707/E17.116

(57) ABSTRACT

Disclosed is a system and method for checking and identifying plurality of portal events of a portal page within a portal. The portal is checked for the plurality of portal events which are non-interconnected within the portal. Further, identifying a non-interconnected set of the plurality of portal events within the portal and outputting the non-interconnected set of the plurality of portal events.

### FIELD OF INVENTION

Embodiments of the invention generally relate to the field of designing a portal, and more particularly to a system and method for checking and identifying a plurality of portal events within a portal.

### BACKGROUND

The ability to efficiently share and retrieve information on a worldwide scale has become increasingly important as businesses and organizations become more globalized. A portal brings together various applications from an intranet to an internet that may be connected to each other. The portal includes a portal event. The portal event may be a link to an address, a software application, a uniform resource locator (URL), and a hypertext markup language. The portal allows creation of the portal templates for generating portal events. Editing the portal generally involves placing content components on the portal. The editing occurs in a user interface that provides a schematic representation of the portal, including a schematic list of containers that hold run time content. One important consideration while editing the portal is its exact run time appearance. For example, components of the portal event may include reciprocal relation between content component appearances, an interaction between content components, an address, a URL and other hypertext markup language elements on the portal. Traditionally, the portal template is generated and used in a functional working and live environment, with backend systems connected to provide run time content. This is done in order to test the actual run time appearance of the portal. The configuration data of the portal includes the portal event, having complex configuration data and connectivity with other applications. Further, a user using the portal or a programmer designing the portal configuration data cannot see the errors generated at run time or design time, and cannot determine whether the portal event connected at back end or front end are exchanging the information with the selected business partner between different portals.

### SUMMARY OF INVENTION

Disclosed is a system and method for checking and identifying plurality of portal events of a portal page within a portal. The portal is checked for the plurality of portal events which are non-interconnected within the portal. Further, identifying a non-interconnected set of the plurality of portal events within the portal and outputting the non-interconnected set of the plurality of portal events.

### BRIEF DESCRIPTION OF THE DRAWINGS

A better understanding of embodiments of the invention is illustrated by examples and not by way of limitation. The embodiments can be obtained from the following detailed description in conjunction with the following drawings, in which:

FIG. 1 is a flow diagram of a method illustrating an embodiment of the invention.

FIG. 2 illustrates the interconnectivity of portal events of a portal page between a first portal and a second different portal.

FIG. 3 illustrates non-interconnected portal events of a portal page within a portal.

FIG. 4 is a flow diagram for detecting interconnected and non-interconnected set of portal events of a portal page within a portal.

FIG. 5 is a block diagram of an embodiment of the invention.

### DETAILED DESCRIPTION

Disclosed is a system and method for checking and identifying plurality of portal events of a portal page within a portal. The portal is checked for the plurality of portal events which are non-interconnected within the portal. Further, identifying a non-interconnected set of the plurality of portal events within the portal and outputting the non-interconnected set of the plurality of portal events.

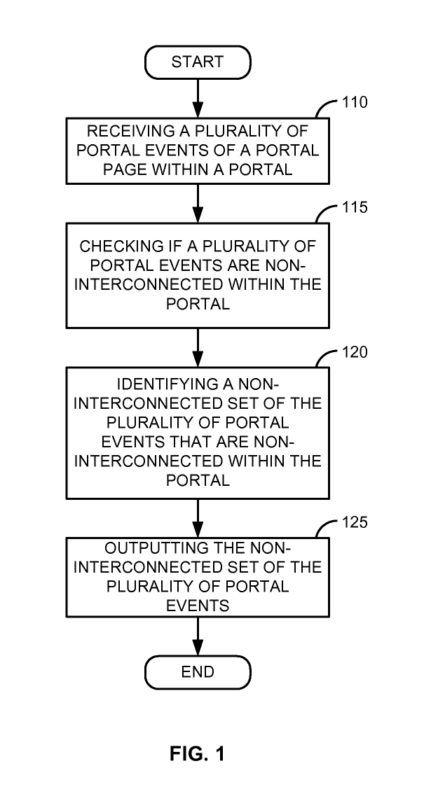

FIG. 1 is a flow diagram of a method illustrating an embodiment of the invention. At process block 110, a plurality of portal events of a portal page within a portal is received. The portal may be a web-based application having a graphical user interface. Receiving the portal event includes receiving a content of the portal. The content of the portal may include metadata of the portal event such as a link to an address, a software application, a URL, a hypertext markup language, a link between the portal event to another portal event, front end and back end connectivity between an application.

At process block 115, a plurality of portal events that are non-interconnected within the portal is checked. This includes checking connectivity between the portal event and the content of the portal. Checking the plurality of portal events that are interconnected includes checking a configuration data of the plurality of portal events within the portal. The configuration data of the portal event may include a link to an address, a software application, a URL, a hypertext markup language, a link between the portal event to another portal event, front end and back end connectivity between a portal event. Further, the configuration data of the plurality of portal events within the portal is checked at run time or at design time. The plurality of portal events may be interconnected within the portal or interconnected with other plurality of portal events of another portal. The plurality of portal events that are non-interconnected within the portal may include but is not limited to an incorrect address, an infinite loop, an unaddressed portal event and a portal event without a target.

At process block 120, a non-interconnected set of the plurality of portal events within the portal is identified. The non-interconnected set of the plurality of portal events may include a broken link between portal event for connectivity, front end and back end non connectivity between a portal event, an incorrect address, an infinite loop, an unaddressed event, a portal event without any configured portal event, an address of the portal and a URL. Identifying the non-interconnected set of the plurality of portal events includes identifying a directly connected set and indirectly connected set of the plurality of portal events within the portal. Further, identifying the plurality of portal events that are non-interconnected may include an event selected from a group consisting of an incorrect address, an infinite loop, an unaddressed plurality of portal events or a plurality of portal events without a target.

At process block 125, the non-interconnected set of the plurality of portal events is outputted.

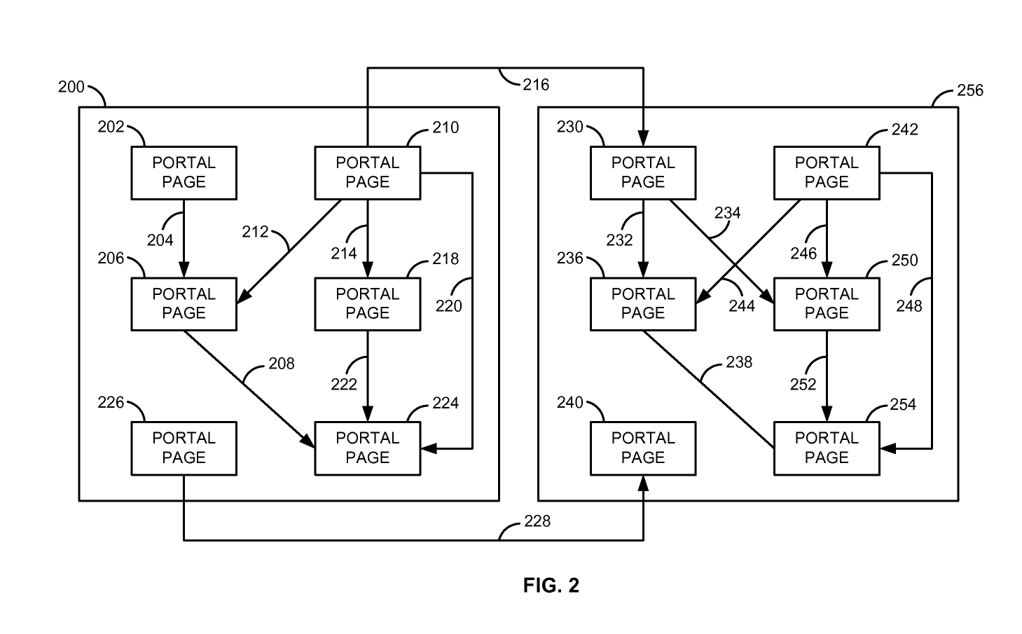

FIG. 2 illustrates the interconnectivity of portal events of a portal page between a first portal and a second portal. As illustrated in FIG. 2, a first portal 200 has a plurality of portal pages including portal page 202, portal page 206, portal page 210, portal page 218, portal page 224 and portal page 226. Further, a second portal 256 has a plurality of portal pages including portal page 230, portal page 236, portal page 240, portal page 242, portal page 250 and portal page 254. The portal pages may be mutually connected to one another. Portal page 202 is interconnected to the portal page 206 via portal event 204. Portal page 206 is interconnected to the portal page 224 via portal event 208. Portal page 210 is interconnected to portal page 206 via portal event 212, portal page 218 via portal event 214 and portal page 224 via portal event 220. Portal page 210 is also connected to portal page 230 of second portal 256 via portal event 216. Portal page 218 is interconnected to portal page 224 via portal event 222. Portal page 226 is interconnected to portal page 240 in second portal 256 via portal event 228. In second portal 256, portal page 230 is interconnected to portal page 236 via portal event 232 and portal page 250 via portal event 234. Portal page 242 is interconnected to portal page 236 via portal event 244, to portal page 250 via 246 and to portal page 254 via portal event 248. Portal event 250 is interconnected to portal page 254 via portal event 252. The plurality of portal pages may be interconnected within the first portal or interconnected with other plurality of portal pages of a second portal. Each portal page checks the plurality of portal events that are non-interconnected within the portal including checking a configuration data of the plurality of portal events within the portal. The configuration data of the portal may include a link to an address, a software application, a URL, a hypertext markup language, a link between the portal event to another portal event, front end and back end connectivity between a portal event. Further, the configuration data of the plurality of portal events is checked within the portal at run time or at design time.

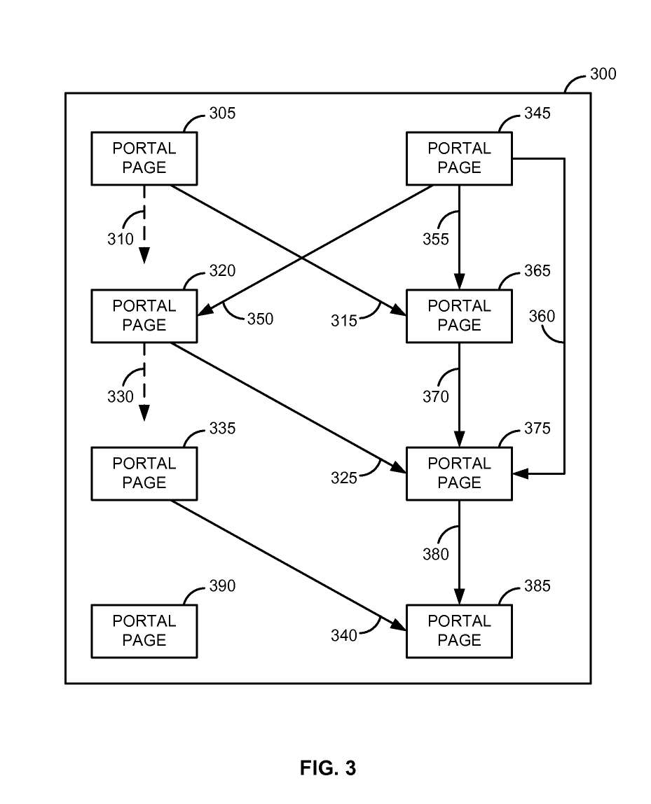

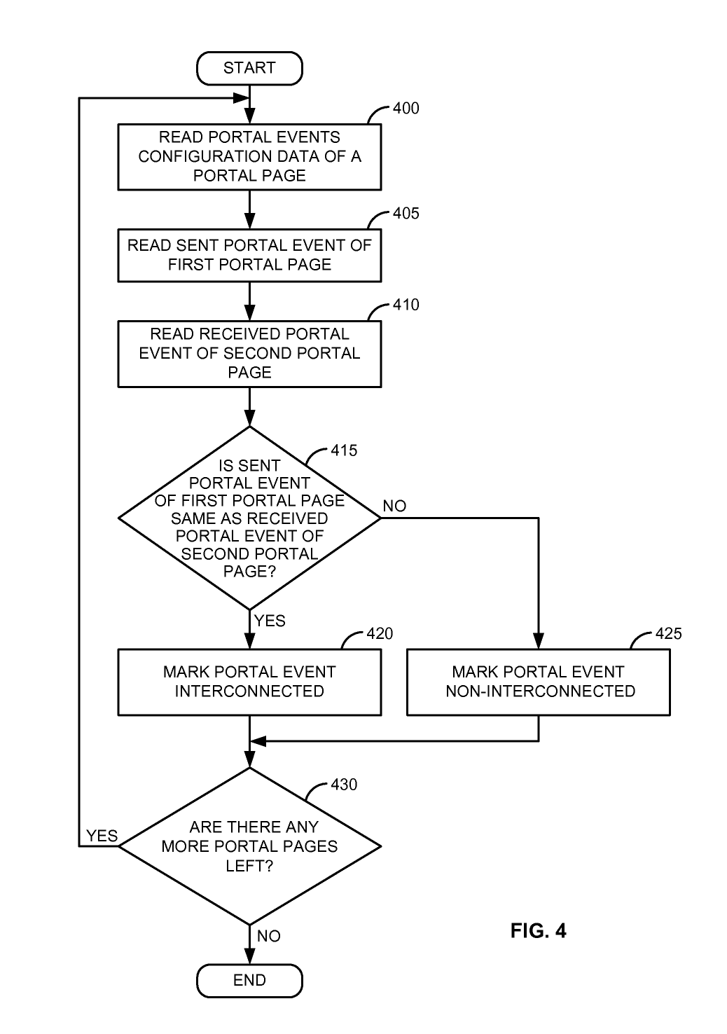

FIG. 3 illustrates non-interconnected portal events of a portal page within a portal. In FIG. 3, checking and identifying plurality of portal events within a portal 300 is explained. The non-interconnected portal events within the portal are checked, which includes checking connectivity between a portal event and a content of the portal. Portal page 305 is interconnected with portal page 365 via portal event 315. Portal page 320 is interconnected to portal page 375 via portal event 325. Portal page 335 is interconnected to portal page 385 via portal event 340. Portal page 345 is interconnected to portal page 320 via portal event 350, portal page 365 via portal event 355 and portal page 375 via portal event 360. Portal page 375 is interconnected to portal page 385 via portal event 380. While checking for interconnected portal events, the portal event 310 of portal page 305 and the portal event 330 of the portal page 320 are found to be non-interconnected within the portal. Portal page 390 is has no portal events. Detecting a non-interconnected portal event is further described in FIG. 4

To identify non-interconnected portal events such as portal event 310 and portal event 330, the configuration data of the plurality of portal events within the portal is checked and identified. The configuration data of the portal event may include a link to an address, a software application, a URL, a hypertext markup language, a link between the portal event to another portal event, front end and back end connectivity between a portal event. Further, the configuration data of the plurality of portal events is checked within the portal at run time or at design time. The plurality of portal events may be interconnected within the portal or interconnected with other plurality of portal events of a different portal. The plurality of portal events that are non-interconnected within the portal may include but is not limited to an incorrect address, an infinite loop, an unaddressed portal event, and a portal event without a target. The portal event 310 and portal event 330 may be an incomplete portal event and may include a broken link between portal event connectivity, front end and back end connectivity between a portal event, an incorrect address, an infinite loop, an unaddressed portal event, a portal event without any configured portal event, an address of the portal, or URL.

FIG. 4 is a flow diagram for detecting interconnected and non-interconnected set of portal events of a portal page within a portal. The portal event configuration data is read for a portal page at process block 400. The sent portal event of a first portal page is read at process block 405. The received portal events of second portal page are read at process block 410. The sent portal event of the first portal page and the received portal event of the second portal page are compared at decision block 415. If the sent portal event of the first portal page is same as the received portal event of the second portal page, the sent portal event and received portal event is marked as interconnected at process block 420. Further if the sent portal event of the first portal page is not as same as the received portal event of the second portal page, the sent portal event and received portal event is marked as non-interconnected at process block 425. If there are more portal pages the above steps are repeated for all the portal pages within a portal at decision block 430.

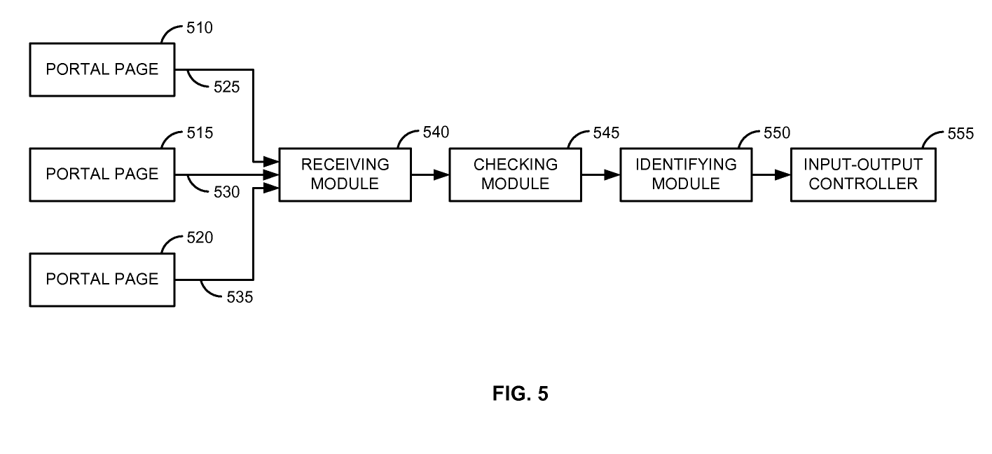

FIG. 5 is a block diagram of an embodiment of the invention. The receiving module 540 receives portal event 525, portal event 530 and portal event 535 from portal page 510, portal page 515 and portal page 520 respectively. The portal page may be a web-based application having a graphical user interface. Receiving the portal event 525, portal event 530 and portal event 535 includes receiving a content of the portal page. The content of the portal page may include metadata of the portal event such as a link to an address, a software application, a URL, a hypertext markup language, a link between the portal event to another portal event, front end and back end connectivity between a portal event. A checking module 545 is electronically coupled to the receiving module 540, for checking the plurality of portal events that are interconnected within the portal. The checking module 545 checks the interconnectivity between a portal event and a content of the portal. Checking the plurality of portal events that are interconnected includes checking a configuration data of the plurality of portal events within the portal. The configuration data of the portal event may include a link to an address, a software application, a URL, a hypertext markup language, a link between the portal event to another portal event, front end and back end connectivity between a portal event. The configuration data of the plurality of portal events within the portal is checked at run time or at design time. The plurality of portal events may be interconnected within the portal and interconnected with other plurality of portal events of a different portal. The plurality of portal events that are non-interconnected within the portal may include but is not limited to an incorrect address, an infinite loop, an unaddressed portal event, or a portal event without a target. An identifying module 550 is electronically coupled to the checking module 545, to identify a non-interconnected set of the plurality of portal events within the portal. The non-interconnected set of the plurality of portal events may include a broken link between portal event for connectivity, front end and back end connectivity between a portal event may not be connected, an incorrect address, an infinite loop, an unaddressed event, a portal event without any configured portal event, an address of the portal, and an URL. Identifying the non-interconnected set of the plurality of portal events includes identifying a directly connected set and indirectly connected set of the plurality of portal events within the portal. Further, identifying the plurality of portal events that are non-interconnected may include an event selected from a group consisting of an incorrect address, an infinite loop, an unaddressed plurality of portal events, or the plurality of portal events without a target. An input output controller 555 is electronically coupled to the identifying module 550, to output the non-interconnected set of the plurality of portal events.

Elements of embodiments of the present invention may also be provided as a machine-readable medium for storing the machine-executable instructions. The machine-readable medium may include, but is not limited to, flash memory, optical disks, CD-ROMs, DVD ROMs, RAMs, EPROMs, EEPROMs, magnetic or optical cards, or other type of machine-readable media suitable for storing electronic instructions.

It should be appreciated that reference throughout this specification to one embodiment or an embodiment means that a particular feature, structure or characteristic described in connection with the embodiment is included in at least one embodiment of the present invention. These references are not necessarily all referring to the same embodiment. Furthermore, the particular features, structures or characteristics may be combined as suitable in one or more embodiments of the invention.

What is claimed is:

1. A method, comprising:
receiving a plurality of portal events of a portal page within a portal;
checking if one or more of the plurality of portal events are non-interconnected within the portal;
identifying a non-interconnected set of the plurality of portal events within the portal; and
outputting the non-interconnected set of the plurality of portal events.

2. The method of claim 1, wherein checking and identifying a non-interconnected set of portal events further comprising:
reading a portal event configuration data of a portal page;
reading a sent portal event of a first portal page;
reading a received portal event of a second portal page;
comparing the sent portal event of the first portal page and the received portal event of the second portal page; and
marking the sent portal event and the received portal event as a non-interconnected event if the sent portal event and the received portal event are not same.

3. The method of claim 1, wherein identifying a non-interconnected set comprises identifying a set of the plurality of portal events that are not interconnected with other plurality of portal events of a different portal.

4. The method of claim 1, wherein the plurality of portal events comprises an event selected from a group consisting of an address to a link, a software application, a uniform resource locator and a hypertext markup language.

5. The method of claim 1, wherein receiving a plurality of portal events within a portal comprises receiving a content of the portal.

6. The method of claim 1, further comprising identifying a directly connected set and an indirectly connected set of the plurality of portal events within the portal.

7. The method of claim 1, wherein checking the plurality of portal events that are interconnected comprises checking a configuration data of the plurality of portal events within the portal.

8. The method of claim 1, further comprising checking the configuration data of the plurality of portal events within the portal at run time.

9. The method of claim 1, further comprising checking the configuration data of the plurality of portal events within the portal at design time.

10. The method of claim 1, wherein identifying the plurality of portal events that are non-interconnected comprises an event selected from a group consisting of an incorrect address, an infinite loop, an unaddressed plurality of portal events, or a plurality of portal events without a target.

11. A machine-accessible medium that provides instructions that, when executed by a machine, cause the machine to perform operations comprising:
receiving a plurality of portal events of a portal page within a portal;
checking if one or more of the plurality of portal events are non-interconnected within the portal;
identifying a non-interconnected set of the plurality of portal events; and
outputting the non-interconnected set of the plurality of portal events.

12. The article of claim 11, wherein identifying a non-interconnected set comprises identifying a set of the plurality of portal events that are not interconnected with other plurality of portal events of a different portal.

13. The article of claim 11, wherein the plurality of portal events comprises an event selected from a group consisting of an address to a link, a software application, a uniform resource locator, and a hypertext markup language.

14. The article of claim 11, further comprising identifying a directly connected set and indirectly connected set of the plurality of portal events within the portal.

15. The article of claim 11, wherein checking the plurality of portal events that are non-interconnected comprises checking a configuration data of the plurality of portal events within the portal.

16. The article of claim 11, further comprising checking the configuration data of the plurality of portal events within the portal at run time.

17. The article of claim 11, further comprising checking the configuration data of the plurality of portal events within the portal at design time.

18. The article of claim 11, wherein identifying the plurality of portal events that are non-interconnected comprises an event selected from a group consisting of an incorrect address, an infinite loop, an unaddressed plurality of portal events, or a plurality of portal events without a target.

19. A system, comprising:
a receiving module for receiving a plurality of portal events of a portal page within a portal;
a checking module electronically coupled to the receiving module, for checking the plurality of portal events that are interconnected within the portal;
an identifying module electronically coupled to the checking module, for identifying a non-interconnected set of the plurality of portal events and
an input-output controller electronically coupled to the identifying module, for outputting the non-interconnected set of the plurality of portal events.
